(19) United States
(12) Patent Application Publication
(10) Pub. No.: US 2026/0341268 A1
(43) Pub. Date: Oct. 29, 2026

(54) AUDIO GENERATION

(71) Applicant: Beijing Zitiao Network Technology Co., Ltd., Beijing (CN)

(72) Inventor: Junjie PAN, Beijing (CN)

(21) Appl. No.: 19/653,840

(22) Filed: Apr. 21, 2026

(30) Foreign Application Priority Data
Apr. 21, 2025 (CN) 202510500825.8

(51) Int. Cl. G10L 13/08; G10L 13/027; G10L 13/033

(52) U.S. Cl. CPC G10L 13/08; G10L 13/027; G10L 13/033

(57) ABSTRACT

Embodiments of the disclosure relate to a method, an apparatus, a device, and a medium for audio generation. The method proposed herein includes: determining, from text content, a text segment to be processed; constructing contextual information associated with the text segment based on associated content of the text segment in the text content, the associated content including at least one of: a preceding segment of the text segment, a subsequent segment of the text segment; and providing the text segment and the contextual information to a model to generate audio content corresponding to the text segment, where at least one expressive attribute of the audio content is determined based on the contextual information.

### CROSS-REFERENCE

The present application claims priority to Chinese Patent Application No. 202510500825.8, filed on Apr. 21, 2025, and entitled “METHOD, APPARATUS, DEVICE, AND STORAGE MEDIUM FOR AUDIO GENERATION”, which is incorporated herein by reference in its entirety.

### FIELD

Example embodiments of the present disclosure generally relate to the field of computers, and in particular to audio generation.

### BACKGROUND

With the development of computer technology, some platforms or applications provide various audio contents to users, which brings great convenience to users. For example, some platforms or applications may provide audio content corresponding to some text content for users, so that users may not only view the text content, but also listen to the corresponding audio content. How to improve the quality of audio generation is a focus of attention.

### SUMMARY

In a first aspect of the present disclosure, a method for audio generation is provided. The method includes: determining, from text content, a text segment to be processed; constructing contextual information associated with the text segment based on associated content of the text segment in the text content, the associated content including at least one of: a preceding segment of the text segment, a subsequent segment of the text segment; and providing the text segment and the contextual information to a model to generate audio content corresponding to the text segment, where at least one expressive attribute of the audio content is determined based on the contextual information.

In a second aspect of the present disclosure, an apparatus for audio generation is provided. The apparatus includes: a first determining module configured to determine, from text content, a text segment to be processed; a constructing module configured to construct contextual information associated with the text segment based on associated content of the text segment in the text content, the associated content including at least one of: a preceding segment of the text segment, a subsequent segment of the text segment; and a providing module configured to provide the text segment and the contextual information to a model to generate audio content corresponding to the text segment, where at least one expressive attribute of the audio content is determined based on the contextual information.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium stores a computer program executable by a processor to implement the method of the first aspect.

It would be appreciated that the content described in this section is neither intended to define key or essential features of the embodiments of the present disclosure, nor is it intended to limit the scope of the present disclosure. Other features of the present disclosure will be readily understood through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference numerals refer to the same or similar elements, where:

FIG. 1 shows a schematic diagram of an example environment in which the embodiments according to the present disclosure may be implemented;

FIG. 2 shows a schematic block diagram of an example process for generating audio content according to some embodiments of the present disclosure;

FIG. 3 shows a flowchart of an example process of audio generation according to some embodiments of the present disclosure;

FIG. 4 shows a schematic structural block diagram of an example apparatus for audio generation according to some embodiments of the present disclosure; and

FIG. 5 shows a block diagram of an electronic device capable of implementing multiple embodiments of the present disclosure.

### DETAILED DESCRIPTION

Hereinafter, embodiments of the present disclosure will be described in more detail with reference to the drawings. Although some embodiments of the present disclosure are shown in the drawings, it would be appreciated that the present disclosure may be implemented in various forms and should not be construed as limited to the embodiments set forth herein. On the contrary, these embodiments are provided for a more thorough and complete understanding of the present disclosure. It would be appreciated that the drawings and embodiments of the present disclosure are only for illustrative purposes, and are not intended to limit the protection scope of the present disclosure.

It should be noted that the titles of any section/subsection provided herein are not restrictive. Various embodiments are described throughout this article, and any type of embodiments may be included under any section/subsection. In addition, the embodiments described in any section/subsection may be combined with any other embodiments described in the same section/subsection and/or different section/subsection in any way.

In the description of the embodiments of the present disclosure, the term “include/comprise” and similar terms should be understood as open-ended inclusions, that is, “include/comprise but not limited to”. The term “based on” should be understood as “based at least in part on”. The term “one embodiment” or “the embodiment” should be understood as “at least one embodiment”. The term “some embodiments” should be understood as “at least some embodiments”. Other definitions, either explicit or implicit, may also be included below. The terms “first”, “second”, etc. may refer to different or same objects. Other definitions, either explicit or implicit, may also be included below.

The embodiments of the present disclosure may involve user data, data acquisition, and/or data usage. These aspects all comply with corresponding laws, regulations and related provisions. In the embodiments of the present disclosure, all data collection, acquisition, processing, machining, forwarding, and usage are performed on the premise that the user is informed and has confirmed. Correspondingly, when implementing the embodiments of the present disclosure, the user should be informed of the type, usage scope, usage scenarios, etc., of data or information that may be involved, and the authorization of the user should be obtained, through appropriate means according to relevant laws and regulations. The specific means of informing and/or authorizing may be changed according to actual situations and application scenarios, and the scope of the present disclosure is not limited in this regard.

If the solutions in this specification and embodiments involve personal information processing, the processing will be performed on the premise that there is a legal basis (for example, the consent of the personal information subject is obtained, or it is necessary for the performance of a contract, etc.), and the processing will only be performed within the scope of provisions or agreements. If a user refuses to process personal information other than the necessary information required for basic functions, it will not affect the user's use of the basic functions.

As mentioned above, with the development of computer technology, some platforms or applications provide various audio contents to users, which brings great convenience to users. For example, some platforms or applications may provide audio content corresponding to some text content for users, so that users may not only view the text content, but also listen to the corresponding audio content.

Embodiments of the present disclosure propose a solution for audio generation. According to this solution, a text segment to be processed may be determined from text content. Furthermore, contextual information associated with the text segment may be constructed based on associated content of the text segment in the text content, the associated content including at least one of: a preceding segment of the text segment, a subsequent segment of the text segment. Additionally, the text segment and the contextual information may be provided to a model to generate audio content corresponding to the text segment, at least one expressive attribute of the audio content being determined based on the contextual information.

Based on this approach, the at least one expressive attribute of the audio content in the embodiments of the present disclosure may be determined based on the contextual information associated with the text segment, without the need to analyze the text segment through limited label tagging or limited categories of classification tools, thereby the accuracy of the at least one expressive attribute may be improved to improve the quality of the audio content. Furthermore, the embodiments of the present disclosure based on such contextual information may also support more accurate understanding of information such as semantics of the text segment, and therefore the accuracy of the at least one expressive attribute may be further improved, so that the quality of the generated audio content may be further improved.

Therefore, the embodiments of the present disclosure are capable of improving the accuracy of at least one expressive attribute of the generated audio content through the contextual information associated with the text segment, thereby the quality of the audio content may be improved.

Various example implementations of this solution will be described in detail below in further conjunction with the drawings.

### Example Environment

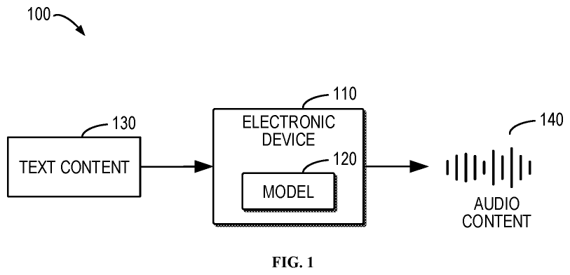

FIG. 1 shows a schematic diagram of an example environment 100 in which the embodiments of the present disclosure may be implemented. As shown in FIG. 1, the example environment 100 may include an electronic device 110.

In this example environment 100, the electronic device 110 may support invoking a model 120 to generate audio content. The model 120 may be any appropriate generative model application for audio generation, which may generate corresponding audio content (e.g., audio 140) based on an input text (e.g., text content 130).

In some embodiments, the electronic device 110 may include a terminal device and/or a server to implement audio generation. The model 120 may be deployed in such terminal device or server to support the generation of audio content. The model 120 may also be deployed in other electronic devices, and support being invoked by the electronic device 110, for example, in the form of an interface, to implement the process of generating audio content. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination of the foregoing, including fittings and peripherals of these devices or any combination thereof.

The server may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server may include, for example, a computing system/server, such as a mainframe, an edge computing node, a computing device in a cloud environment, and so on.

A communication connection may be established between the terminal device and the server. The communication connection may be established in a wired or wireless manner. The communication connection may include, but is not limited to, a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the terminal device and the server may implement signaling interaction through the communication connection therebetween.

It would be appreciated that the structure and function of each element in the environment 100 are described for illustrative purposes only, without suggesting any limitation to the scope of the present disclosure.

Some example embodiments of the present disclosure will be continuously described below with reference to the drawings.

### Example Audio Generation Process

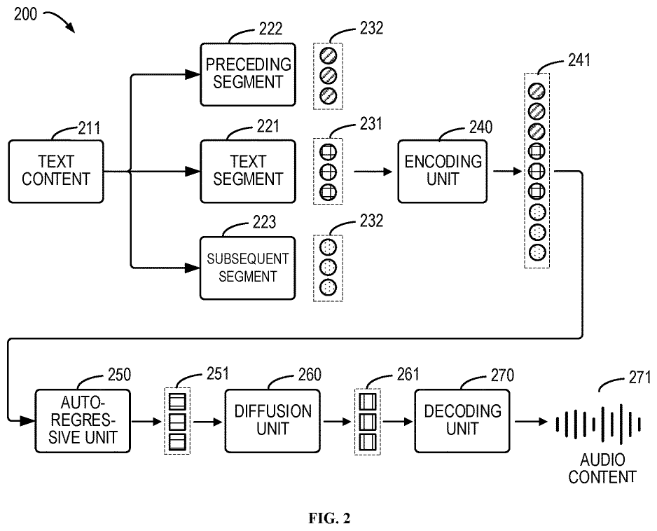

Some example audio generation processes according to the embodiments of the present disclosure will be described below with reference to FIG. 2. FIG. 2 shows a schematic block diagram of an example process 200 of generating audio content according to some embodiments of the present disclosure. The process 200 may be implemented, for example, at the electronic device 110 shown in FIG. 1.

In some embodiments, such process 200 may be used in a text-to-speech scenario. As an example, such text may include any suitable literary work content, examples of which include, but are not limited to, a novel book, a script book, etc. As an example, such text may include text content of multiple language expression types, such as a dialogue part (e.g., a dialogue between multiple characters), a narration part, etc.

In order to improve the reading efficiency of users, some traditional solutions use a classification model to predict labels such as emotion, paralinguistics, and speaker for each sentence of a text, and generate, based on the prediction results of such labels, corresponding audio segments sentence by sentence which are then concatenated into audio corresponding to the text. However, such labels usually need to be manually designed in advance, so that such labels are limited to a finite label set and to human experience, which in turn leads to low quality of audio generated based on such labels. In view of this, embodiments of the present disclosure provides an audio generation solution that is capable of improving audio quality. Hereinafter, with reference to FIG. 2, such audio generation solution will be illustratively described by taking the generation of audio corresponding to text content 211 as an example.

In some embodiments, according to the process 200 shown in FIG. 2, the electronic device 110 may obtain a text segment to be processed from the text content 211. As an example, such text content 211 may be complete chapter content in literary work content (e.g., all content of one chapter in a novel book). Such chapter content may include more than a specified number of sentences. Thus, such chapter content may have a continuous story line, a relatively complete plot, a relatively complete scene, etc., so that such text segment may be more relevant to its preceding text content and/or its subsequent text content.

In order to improve the integrity of audio generated based on the text content 211, the electronic device 110 may set a sliding window to segment the text content 211, to process the segmented text segments separately. As an example, such sliding window may be configured to slide in sentence units, for example, such sliding window may be configured with a sliding step of a fixed predetermined number of sentences. As an example, the text segment to be processed obtained from the text content 211 may be the text segment 221 shown in FIG. 2. In the following, the specific implementation of generating audio content corresponding to a text segment will be illustratively described by taking the generation of corresponding audio content 271 based on the text segment 221 shown in FIG. 2 as an example.

As an example, the embodiments of the present disclosure may generate a plurality of audio content corresponding to a plurality of text segments based on an implementation similar to that of generating the audio content 271, and then concatenate the plurality of audio content corresponding to the plurality of text segments to generate target audio content corresponding to the text content 211. The present disclosure does not intend to limit the specific implementation of such concatenating, which will not be described in detail.

In some embodiments, the electronic device 110 determines associated content of the text segment 221 from the text content 211. Such associated content may be a preceding segment of the text segment 221 (e.g., a last text segment 222 of the text segment 221) and/or a subsequent segment of the text segment 221 (e.g., a next text segment 223 of the text segment 221). As an example, such preceding segment and/or subsequent segment of the text segment 221 may have an association relationship with the text segment 221. For example, such association relationship may include having a continuous story line, having continuous dialogue content, etc. As an example, such preceding segment and/or subsequent segment may be determined from the text content 211 through a sliding window.

In order to enable the model to understand the text segment 221 more accurately, the electronic device 110 may determine such associated content of the text segment 221 from the text content 211 based on a first window size. Such first window size may be the sliding window length of the sliding window described above. As an example, the electronic device 110 may first determine the length of the text segment 221, and deduct the length of the text segment 221 from the first window size to obtain the remaining length. Then, the electronic device 110 may distribute the remaining length to the preceding segment and the subsequent segment of the text segment 221. Thus, the embodiments of the present disclosure may construct contextual information associated with the text segment 221 based on the associated content of the text segment 221.

As an example, the sliding window length and the first window size may be in the unit of number of words, for example, the sliding window length includes N words, and the text segment 221 includes M words, then the electronic device 110 may distribute (N−M)/2 words to the preceding segment and the subsequent segment of the text segment 221, respectively, to obtain a preceding segment containing at most (N−M)/2 words and/or a subsequent segment containing at most (N−M)/2 words. As an example, the electronic device 110 may also distribute lengths to the preceding segment and the subsequent segment of the text segment 221 based on a predetermined ratio, so that the lengths of the preceding segment and the subsequent segment satisfy the predetermined ratio.

In some embodiments, in order to ensure the accuracy of processing text segment by the model described below, such first window size may be smaller than a second window size used for constructing contextual information in the process of training the model, for example, such second window size may indicate the maximum lengths of the preceding segment and the subsequent segment of a training sample segment in the process of training the model.

In some embodiments, such text segment 221 may be a start part or an end part of the text content 211. For example, the text segment 221 may include the first paragraph or the last paragraph of the text content 211. Thus, the electronic device 110 may construct contextual information associated with the text segment 221 based only on the preceding segment of the text segment 221 or based only on the subsequent segment of the text segment 221. As an example, the embodiments of the present disclosure are illustratively described below by taking the construction of contextual information associated with the text segment 221 based on the subsequent segment of the text segment 221 and the preceding segment of the text segment 221 as an example, and other cases may refer to the embodiments of the present disclosure.

Based on this, the electronic device 110 may provide the text segment 221 and the contextual information to the model 120 to generate audio content corresponding to the text segment 221. As an example, such model 120 may at least include an encoding unit 240, an autoregressive unit 250, a diffusion unit 260, and a decoding unit 270 shown in FIG. 2. Then, when the electronic device 110 provides the text segment 221 and the contextual information to the model 120, the model 120 may process the text segment 221 and the contextual information through a plurality of included units, thereby generating audio content corresponding to the text segment 221.

Furthermore, the electronic device 110 may provide the text segment 221 and the contextual information to the encoding unit 240, and obtain an input text embedding 241 output by the encoding unit 240. As an example, such encoding unit 240 may be implemented by any appropriate encoder, which may, for example, generate a corresponding text embedding based on an input text. As an example, such input text embedding 241 may include a first part (e.g., text embedding 232) corresponding to the preceding segment 222, a second part (e.g., text embedding 231) corresponding to the text segment 221, and a third part (e.g., text embedding 233) corresponding to the subsequent content.

In order to improve the accuracy of the model recognizing the text segment 221 to be processed, the second part corresponding to the text segment 221 may be associated with a predetermined identifier. As an example, such identifier may identify the starting point (e.g., such identifier may include a starting point identifier) and the ending point (e.g., such identifier may include an ending point identifier) of such second part. In order to improve the accuracy of the model processing, in the case that the associated content of the text segment 221 does not include the preceding segment or does not include the subsequent segment, the electronic device 110 may also associate the second part corresponding to the text segment 221 with such starting point identifier and ending point identifier.

Furthermore, the electronic device 110 may provide the input text embedding 241 to the autoregressive unit 250 of the model 120 to generate the first audio feature 251. As an example, such first audio feature 251 may be a discrete feature. As an example, such autoregressive unit 250 may be implemented by any appropriate tool or model layer, which may, for example, generate a corresponding audio feature based on the input text embedding. As an example, the first audio feature 251 generated by such autoregressive unit 250 may be a discrete feature. For example, such autoregressive unit 250 may generate a corresponding feature element item by item based on the input text embedding.

In some embodiments, the decoding strategy of such autoregressive unit 250 may adopt a sampling decoding strategy based on a predetermined number. In order to improve the diversity of decoding, the decoding strategy of such autoregressive unit 250 may adopt a decoding strategy based on a predetermined number and a predetermined temperature parameter. The following takes a decoding strategy based on a predetermined number and temperature parameter as an example for example illustration. For the embodiment where such decoding strategy is a sampling decoding strategy based on a predetermined number, reference may be made to the embodiments of the present disclosure below, the difference being that the step of updating the probability distribution by using the predetermined temperature parameter is not performed.

As an example, in the case that the electronic device 110 provides the input text embedding 241 to the autoregressive unit 250 of the model 120, a probability distribution with respect to a target output token may be determined based on such input text embedding 241. Taking the target output token as the ith element, representing the probability of the ith element by the probability distribution pᵢ, and updating the probability distribution of the target input token using a predetermined temperature parameter T (e.g., such temperature parameter T may adjust the shape of such probability distribution) as an example, such probability distribution pᵢ may be expressed as formula (1).

$${p}_{i}^{new 1} = \frac{exp ( \frac{log ( {p}_{i} )}{T} )}{{\sum }_{j} exp ( \frac{log ( {p}_{i} )}{T} )} \qquad ( 1 )$$

Thus, the electronic device 110 may determine a plurality of candidate elements with respect to the ith element through such autoregressive unit 250. Furthermore, the electronic device 110 may sort the plurality of candidate elements through such autoregressive unit 250. For example, the probability distribution of the plurality of sorted candidate elements may be expressed as formula (2).

p′=p′₁,p′₂, . . . ,p′ₙ (2)

Furthermore, the electronic device 110 may determine set of candidate elements with a predetermined number (e.g., k) from the plurality of sorted candidate elements. In order to improve the sampling accuracy, the probability distribution of such a set of candidate elements may be updated. As an example, such updating may include normalization, or other suitable probability distribution adjustment methods, etc. Taking the normalization of the probability distribution of such a set of candidate elements so that the sum of the sampling probabilities of such a set of candidate elements is 1 as an example, the probability distribution of such a set of candidate elements may be adjusted to satisfy the following formula (3).

$${p}_{i}^{new 2} = \frac{{p}_{i}}{{\sum }_{j = 1}^{k} {p}_{i}} \qquad ( 3 )$$

Based on the updated sampling probability, the electronic device 110 may sample the target element corresponding to the ith element from such a set of candidate elements through the autoregressive unit 250.

Based on this, the embodiments of the present disclosure are capable of improving the diversity of sampling through such predetermined number, thereby the quality of the audio content generated by the subsequent model 120 may be improved. Moreover, the embodiments of the present disclosure are capable of balancing the diversity and accuracy of sampling through such predetermined temperature parameter, thereby the quality of the audio content generated by the model 120 subsequently may be further improved.

In some embodiments, because such first audio feature 251 is a discrete feature, the quality of audio content generated directly based on such first audio feature 251 is low. Therefore, in the case that the electronic device 110 generates the first audio feature 251 through the autoregressive unit 250, such first audio feature 251 may be provided to the diffusion unit 260 to supplement information such as semantic information and audio expression information for such first audio feature 251, thereby generating the second audio feature 261. As an example, such second audio feature 261 may be a continuous feature. As an example, such diffusion unit 260 may be implemented by any appropriate tool or model layer, which may, for example, generate a corresponding continuous audio feature for the input discrete audio feature diffusion information.

Furthermore, the electronic device 110 may provide such second audio feature 261 to the decoding unit 270 to generate the audio content 271 corresponding to the text segment 221. As an example, such decoding unit 270 may be implemented by any appropriate decoder, which may, for example, decode and generate corresponding audio content based on the input audio feature. Therefore, the embodiments of the present disclosure may determine at least one expressive attribute of the generated audio content 271 based on such contextual information.

As an example, such at least one expressive attribute may be associated with the character, the performance attribute, the speech expression type, etc. of the text segment 221. For example, based on such contextual information, the embodiments of the present disclosure may determine that the text segment 221 belongs to a dialogue-type text or a narrative-type text, and then generate audio content of a character performance or audio content of a narrative performance. For one further example, based on such contextual information, the embodiments of the present disclosure may determine the character corresponding to the text segment 221, for example, the text segment 221 may be dialogue content of a target character, and then generate audio content that performs the sound effect of the target character.

It would be appreciated that the audio schematic diagram of the audio content 271 in FIG. 2 is only an example description of the embodiments of the present disclosure, without suggesting any limitation to the specific audio content of the audio content 271. In addition, the above specific content items (e.g., length, number of sentences, number of words, probability distribution identification, element identification, identification of temperature parameter, identification of predetermined number, etc.) mentioned in the embodiments of the present disclosure are all illustrative, and the present disclosure does not intend to limit them.

Based on this approach, the embodiments of the present disclosure are capable of improving the accuracy of at least one expressive attribute of the generated audio content through the contextual information associated with the text segment, thereby the quality of the audio content may be improved.

### Example Model Training Process

In order to improve the quality of the audio content generated by the model, such model 120 may be obtained through pre-training. In the following, the case where such model 120 is trained at the electronic device 110 is taken as an example to further describe the example training process of such model 120. It would be appreciated that such model 120 may also be obtained through training in other devices, and may support being invoked or deployed to implement the audio generation process of the present disclosure. The present disclosure only takes the case where the model 120 is obtained through training at the electronic device 110 as an example for illustrative description.

In some embodiments, the electronic device 110 may segment sample text content to obtain a sample text segment. As an example, such sample text content may include any appropriate sample literary work content, which may include, for example, text segments of multiple language expression types, dialogue content related to one or more characters, narration content, etc.

In order to improve the model training effect, the electronic device 110 may segment the sample text content into a plurality of candidate segments based on reference information of the sample text content, and then determine the sample text segment based on the plurality of candidate segments. As an example, such reference information may improve the semantic integrity of the segmented sample text segment.

In order to improve the quality of segmentation, such reference information may indicate the grammatical structure of the sample text content, and such grammatical structure may indicate a plurality of sentences of the sample text content. As an example, such sample text content may be chapter text. Thus, the electronic device 110 may segment such chapter text based on the grammatical structure of the chapter text, and then obtain a sample text segment including a predetermined number of sentences therein. Alternatively, or additionally, such reference information may also indicate semantic information of the sample text content, and such semantic information may indicate speech expression types corresponding to different content in the sample text content. As an example, such speech expression types include, for example, a dialogue type, a narration type, etc. For example, the electronic device 110 may segment the dialogue content corresponding to one character into a sample text segment. For one further example, the electronic device 110 may segment the dialogue content and the narration content into different sample text segments, etc. In this way, the model 120 may more accurately understand the text information of such sample text segment.

In some embodiments, if a candidate segment is too long, the candidate segment may be reasonably segmented to determine the sample text segment. Specifically, in response to the length of a target candidate segment among the plurality of candidate segments being greater than a threshold, the electronic device 110 may segment the target candidate segment based on a predetermined length to determine the sample text segment. As an example, such predetermined length may have a predetermined constraint relationship with such threshold, such predetermined length, such threshold, and such constraint relationship may all be set according to actual project requirements, and the embodiments of the present disclosure do not intend to limit the specific values of such predetermined length and such threshold and the constraint relationship therebetween.

Furthermore, the electronic device 110 may obtain training associated content of the sample text segment from the sample text content based on a predetermined window size (e.g., the second window size). Furthermore, the electronic device 110 may construct training contextual information based on the training associated content. Additionally, the electronic device 110 may obtain the model 120 through training based on the sample text segment, a sample audio segment corresponding to the sample text segment, and the training contextual information. As an example, for the specific implementation of such training process, reference may be made to the similar implementation in the application process of the model 120 in the above audio generation process, and the embodiments of the present disclosure will not repeat it here.

Based on this approach, the embodiments of the present disclosure are capable of providing more information for model training based on sample contextual information associated with the sample text segment, without the need to support the model to analyze such sample text segment through limited label tagging or limited categories of classification tools, thereby the quality of the trained model may be improved. Furthermore, the embodiments of the present disclosure based on such contextual information may also support the model to more accurately understand information such as semantics of the text segment, so that the quality of the trained model may be further improved.

Therefore, the embodiments of the present disclosure are capable of improving the quality of the trained model through the sample contextual information associated with the sample text segment.

### Example Process

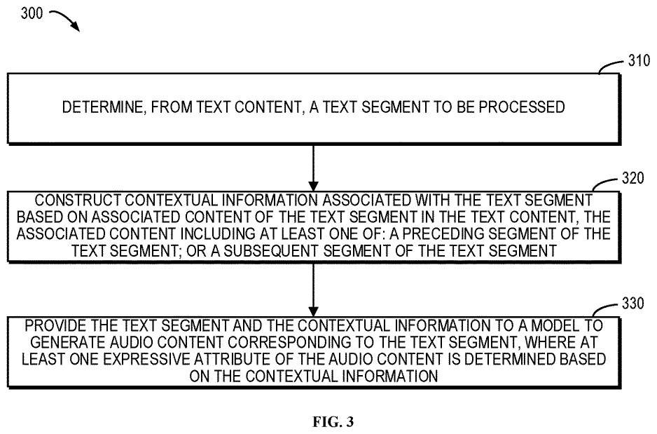

FIG. 3 shows a flowchart of an example audio generation process 300 according to some embodiments of the present disclosure. The process 300 may be implemented at the electronic device 110. The process 300 is described below with reference to FIG. 1.

As shown in FIG. 3, at block 310, the electronic device 110 determines, from text content, a text segment to be processed.

At block 320, the electronic device 110 constructs contextual information associated with the text segment based on associated content of the text segment in the text content, the associated content including at least one of: a preceding segment of the text segment; a subsequent segment of the text segment.

At block 330, the electronic device 110 provides the text segment and the contextual information to a model to generate audio content corresponding to the text segment, where at least one expressive attribute of the audio content is determined based on the contextual information.

In some embodiments, providing the text segment and the contextual information to the model to generate the audio content corresponding to the text segment includes: generating an input text embedding based on the text segment and the contextual information; providing the input text embedding to an autoregressive unit of the model to generate a first audio feature; providing the first audio feature to a diffusion unit of the model to generate a second audio feature; and providing the second audio feature to a decoding unit of the model to generate the audio content corresponding to the text segment.

In this way, the embodiments of the present disclosure are capable of generating the input text embedding based on the text segment and the contextual information, so as to perform feature extraction and decoding on the input text embedding, thereby obtaining more accurate and comprehensive text information corresponding to the text segment and improving the quality of the generated audio content.

In some embodiments, the input text embedding includes: a first part corresponding to the preceding segment; a second part corresponding to the text segment, where the second part is associated with a predetermined identifier; and a third part corresponding to the subsequent content.

In this way, the embodiments of the present disclosure may more accurately distinguish the feature information of the text segment from the feature information of the context for reference, thereby improving the accuracy of subsequent feature extraction.

In some embodiments, the first audio feature is a discrete feature, and the second audio feature is a continuous feature.

In this way, the embodiments of the present disclosure may obtain more comprehensive feature information, thereby further improving the quality of the generated audio content.

In some embodiments, providing the input text embedding to the autoregressive unit of the model to generate the first audio feature includes: determining a probability distribution of the model with respect to a target output token based on the input text embedding; sorting a plurality of candidate elements based on the probability distribution; determining a set of candidate elements with a predetermined number from the plurality of sorted candidate elements; updating sampling probabilities of the p set of candidate elements; and sampling a target element corresponding to the target output token from the set of candidate elements based on the updated sampling probabilities

In this way, the embodiments of the present disclosure are capable of improving the diversity of sampling by using the sampling method based on such predetermined number, thereby improving the diversity of audio generation and reducing the error probability of audio generation, so that the quality of the audio content generated by the subsequent model may be improved.

In some embodiments, the process 300 further includes: updating the probability distribution based on a predetermined temperature parameter before sorting the plurality of candidate elements based on the probability distribution.

In this way, the embodiments of the present disclosure are capable of balancing the diversity and accuracy of model sampling through such predetermined temperature parameter, thereby further improving the quality of the audio content generated by the subsequent model.

In some embodiments, the process 300 further includes: determining the associated content of the text segment from the text content based on a first window size.

In this way, the embodiments of the present disclosure are capable of improving the accuracy of the range of the associated content, so that the contextual information constructed therefrom may have higher quality.

In some embodiments, the first window size is smaller than a second window size for constructing contextual information during a process of training the model.

In this way, the embodiments of the present disclosure are capable of ensuring that the model obtains information associated with the text segment from the contextual information, and avoiding redundant information from interfering with the model to generate audio content, thereby improving the efficiency of audio generation.

In some embodiments, the model is trained based on a process of: segmenting sample text content to obtain sample text segments; obtaining training associated content of the sample text segments from the sample text content based on a predetermined window size; constructing training contextual information based on the training associated content; and training the model based on the sample text segments, sample audio segments corresponding to the sample text segments, and the training contextual information.

In this way, the embodiments of the present disclosure are capable of improving the quality of the model by training such model, thereby improving the quality of the audio content generated based on the model.

In some embodiments, segmenting the sample text content to obtain the sample text segments includes: segmenting the sample text content into a plurality of candidate segments based on reference information of the sample text content; and determining the sample text segments based on the plurality of candidate segments.

In this way, the embodiments of the present disclosure are capable of ensuring the integrity of information such as semantics contained in the sample text segment, and improving the accuracy of the model to recognize the sample text segment, so as to improve the quality of the trained model.

In some embodiments, determining the sample text segments based on the plurality of candidate segments includes: segmenting, in response to the length of a target candidate segment among the plurality of candidate segments being greater than a threshold, segmenting the target candidate segment based on a predetermined length to determine the sample text segment.

In this way, the embodiments of the present disclosure are capable of avoiding using excessively long sample text segments to train the model, thereby improving the stability of the model training process and further improving the efficiency of training the model.

In some embodiments, the reference information indicates at least one of: a grammatical structure of the sample text content, indicating a plurality of sentences of the sample text content; and/or semantic information of the sample text content, indicating speech expression types corresponding to different content in the sample text content.

In this way, the embodiments of the present disclosure are capable of segmenting the sample text content more reasonably, so that the segmented sample text segment may contain more accurate information such as grammar and semantics, thereby further improving the quality of the trained model.

In some embodiments, the text content is all content of a chapter of a novel.

In this way, the embodiments of the present disclosure may process text content that is more relevant between text segments, thereby improving the accuracy of at least one expressive attribute of the audio content determined based on the contextual information.

Based on this approach, the at least one expressive attribute of the audio content in the embodiments of the present disclosure may be determined based on the contextual information associated with the text segment, without the need to analyze the text segment through limited label tagging or limited categories of classification tools, thereby the accuracy of the at least one expressive attribute may be improved to improve the quality of the audio content. Furthermore, the embodiments of the present disclosure based on such contextual information may also support more accurate understanding of information such as semantics of the text segment, and therefore the accuracy of the at least one expressive attribute may be further improved, so that the quality of the generated audio content may be further improved.

Therefore, the embodiments of the present disclosure are capable of improving the accuracy of at least one expressive attribute of the generated audio content through the contextual information associated with the text segment, thereby the quality of the audio content may be improved.

### Example Apparatus and Device

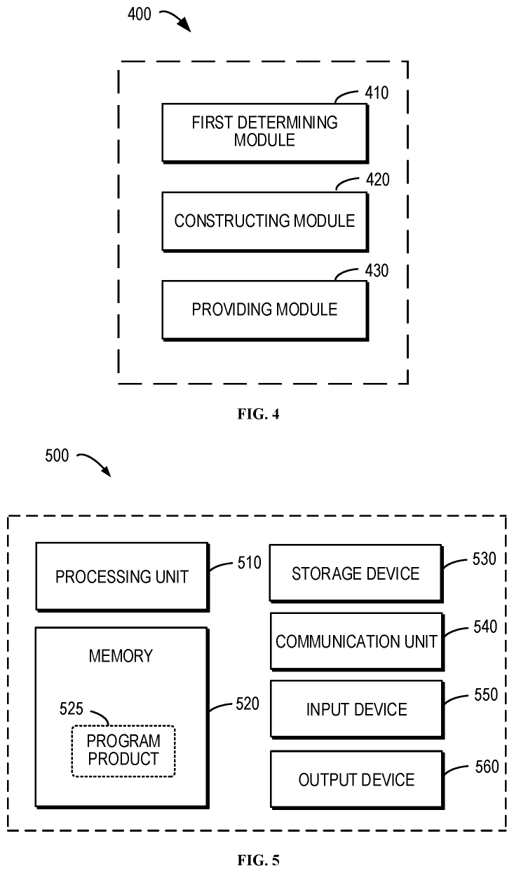

The embodiments of the present disclosure further provide corresponding apparatuses for implementing the above methods or processes. FIG. 4 shows a schematic structural block diagram of an example apparatus 400 for audio generation according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes a first determining module 410 configured to determine, from text content, a text segment to be processed; a constructing module 420 configured to construct contextual information associated with the text segment based on associated content of the text segment in the text content, the associated content including at least one of: a preceding segment of the text segment, a subsequent segment of the text segment; and a providing module 430 configured to provide the text segment and the contextual information to a model to generate audio content corresponding to the text segment, where at least one expressive attribute of the audio content is determined based on the contextual information.

In some embodiments, the providing module 430 is further configured to: generate an input text embedding based on the text segment and the contextual information; provide the input text embedding to an autoregressive unit of the model to generate a first audio feature; provide the first audio feature to a diffusion unit of the model to generate a second audio feature; and provide the second audio feature to a decoding unit of the model to generate the audio content corresponding to the text segment.

In some embodiments, the providing module 430 is further configured to: a first part corresponding to the preceding segment; a second part corresponding to the text segment, where the second part is associated with a predetermined identifier; and a third part corresponding to subsequent content.

In some embodiments, the first audio feature is a discrete feature, and the second audio feature is a continuous feature.

In some embodiments, the providing module 430 is further configured to: determine a probability distribution of the model with respect to a target output token based on the input text embedding; sort a plurality of candidate elements based on the probability distribution; determine a set of candidate elements with a predetermined number from the plurality of sorted candidate elements; update sampling probabilities of the set of candidate elements; and sample a target element corresponding to the target output token from the set of candidate elements based on the updated sampling probabilities.

In some embodiments, the apparatus 400 further includes an updating module configured to: update the probability distribution based on a predetermined temperature parameter.

In some embodiments, the apparatus 400 further includes a second determining module configured to: determine the associated content of the text segment from the text content based on a first window size.

In some embodiments, the first window size is smaller than a second window size for constructing contextual information in a process of training the model.

In some embodiments, the apparatus 400 further includes a model training module configured to: segment sample text content to obtain sample text segments; obtain training associated content of the sample text segments from the sample text content based on a predetermined window size; construct training contextual information based on the training associated content; and train the model based on the sample text segments, sample audio segments corresponding to the sample text segments, and the training contextual information.

In some embodiments, the model training module is further configured to: segment the sample text content into predetermined candidate segments based on reference information of the sample text content; and determine the sample text segments based on the plurality of candidate segments.

In some embodiments, the model training module is further configured to: segment, in response to the length of a target candidate segment among the plurality of candidate segments being greater than a threshold, the target candidate segment based on a predetermined length to determine the sample text segment.

In some embodiments, the reference information indicates at least one of: a grammatical structure of the sample text content, indicating a plurality of sentences of the sample text content; and/or semantic information of the sample text content, indicating speech expression types corresponding to different content in the sample text content.

In some embodiments, the text content is all content of a chapter of a novel.

The modules included in the apparatus 400 may be implemented in various ways, including software, hardware, firmware, or any combination thereof. In some embodiments, one or more units may be implemented using software and/or firmware, for example machine executable instructions stored on a storage medium. In addition to machine executable instructions or as an alternative, some or all modules in the apparatus 400 may be implemented at least partially by one or more hardware logic components. As an example, rather than a limitation, example types of hardware logic components that may be used include field programmable gate array (FPGA), application specific integrated circuit (ASHC), application specific standard (ASSP), system on chip (SOC), complex programmable logic device (CPLD), and so on.

FIG. 5 shows a block diagram of an electronic device 500 in which one or more embodiments of the present disclosure may be implemented. It would be appreciated that the electronic device 500 shown in FIG. 5 is only illustrative, without suggesting any limitation to the function and scope of the embodiments described herein. The electronic device 500 shown in FIG. 5 may be used to implement the electronic device 110 in FIG. 1 or the apparatus 400 in FIG. 4.

As shown in FIG. 5, the electronic device 500 is in the form of a general electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and may execute various processes based on the programs stored in the memory 520. In a multiprocessor system, multiple processing units execute computer executable instructions in parallel to improve the parallel processing capability of the electronic device 500.

The electronic device 500 typically includes multiple computer storage medium. Such medium may be any available medium accessible by the electronic device 500, including but not limited to volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be a removable or non-removable medium, and may include a machine readable medium such as a flash drive, a disk, or any other medium, which may be used to store information and/or data and may be accessed within the electronic device 500.

The electronic device 500 may further include additional removable/non-removable, volatile/non-volatile storage medium. Although not shown in FIG. 5, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 implements communication with other electronic devices through the communication medium. Additionally, the functions of the components of the electronic device 500 may be implemented by a single computing cluster or multiple computing machines, which may communicate through communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may also communicate with one or more external devices (not shown) through the communication unit 540 as needed, the external devices such as a storage device, a display device, or the like, communicate with one or more devices that enable the user to interact with the electronic device 500, or communicate with any devices (e.g., a network card, a modem, etc.) that enable the electronic device 500 to communicate with one or more other electronic devices. Such communication may be performed via input/output (H/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is also provided a computer program product being tangibly stored on a non-transitory computer-readable medium and including computer-executable instructions, and the computer-executable instructions are executed by a processor to implement the method described above.

Various aspects of the present disclosure are described here with reference to the flowcharts and/or block diagrams of the method, apparatus, device, and computer program product implemented according to the present disclosure. It would be appreciated that each block of the flowcharts and/or block diagrams, and the combination of each block in the flowcharts and/or block diagrams may be implemented by computer-readable program instructions.

These computer-readable program instructions may be provided to the processing unit of a general computer, a special computer, or other programmable data processing apparatus, thereby producing a machine, so that when these instructions are executed by the processing unit of a computer or other programmable data processing apparatus, the apparatus for implementing the function/action specified in one or more blocks of the flowcharts and/or block diagrams is produced. These computer-readable program instructions may also be stored in a computer-readable storage medium, and these instructions cause computers, programmable data processing apparatus, and/or other devices work in a specific way, and thus the computer-readable medium storing the instructions includes an article of manufacture, which includes instructions for implementing various aspects of the function/action specified in one or more blocks of the flowcharts and/or block diagrams.

The computer-readable program instructions may be loaded onto a computer, other programmable data processing apparatus, or other apparatus, so that a series of operations and steps are performed on the computer, other programmable data processing apparatus, or other apparatus, to produce a computer-implemented process, so that the instructions executed on the computer, other programmable data processing apparatus, or other apparatus implement the functions/actions specified in one or more blocks of the flowcharts and/or block diagrams.

The flowcharts and block diagrams in the drawings show architecture, functionality, and operation of possible implementations of the system, the method, and the computer program product according to multiple implementations of the present disclosure. In this regard, each block in the flowcharts or block diagrams may represent a module, a program segment, or a part of instruction, and the module, the program segment, or the part of the instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It also needs to be noted that each block in the block diagrams and/or flowcharts, and the combination of the blocks in the block diagrams and/or flowcharts may be implemented by a dedicated hardware-based system that executes specified functions or actions, or may be implemented by a combination of dedicated hardware and computer instructions.

The implementations of the present disclosure have been described above, and the above description is illustrative, non-exhaustive, and not limited to the disclosed implementations. Without departing from the scope of the illustrated implementations, many modifications and changes are obvious to those of ordinary skill in the art. The choice of terms used herein is intended to best explain the principles of the implementations, the actual applications or improvements to the technologies in the market, or to enable other ordinary technicians in the art to understand the implementations disclosed herein.

1. A method for audio generation, comprising:
determining, from text content, a text segment to be processed;
constructing contextual information associated with the text segment based on associated content of the text segment in the text content, the associated content comprising at least one of: a preceding segment of the text segment; or a subsequent segment of the text segment; and
providing the text segment and the contextual information to a model to generate audio content corresponding to the text segment, wherein at least one expressive attribute of the audio content is determined based on the contextual information.

2. The method of claim 1, wherein providing the text segment and the contextual information to the model to generate the audio content corresponding to the text segment comprises:
generating an input text embedding based on the text segment and the contextual information;
providing the input text embedding to an autoregressive unit of the model to generate a first audio feature;
providing the first audio feature to a diffusion unit of the model to generate a second audio feature; and
providing the second audio feature to a decoding unit of the model to generate the audio content corresponding to the text segment.

3. The method of claim 2, wherein the input text embedding comprises:
a first part corresponding to the preceding segment;
a second part corresponding to the text segment, wherein the second part is associated with a predetermined identifier; and
a third part corresponding to the subsequent content.

4. The method of claim 2, wherein the first audio feature is a discrete feature, and the second audio feature is a continuous feature.

5. The method of claim 2, wherein providing the input text embedding to the autoregressive unit of the model to generate the first audio feature comprises:
determining a probability distribution of the model with respect to an output token based on the input text embedding;
sorting a plurality of candidate elements based on the probability distribution;
determining a set of candidate elements with a predetermined number from the plurality of sorted candidate elements;
updating sampling probabilities of the set of candidate elements; and
sampling an element corresponding to the output token from the set of candidate elements based on the updated sampling probabilities.

6. The method of claim 5, further comprising:
updating the probability distribution based on a predetermined temperature parameter before sorting the plurality of candidate elements based on the probability distribution.

7. The method of claim 1, further comprising:
determining the associated content of the text segment from the text content based on a first window size.

8. The method of claim 7, wherein the first window size is smaller than a second window size for constructing contextual information during a process of training the model.

9. The method of claim 1, wherein the model is trained based on a process of:
segmenting sample text content to obtain sample text segments;
obtaining training associated content of the sample text segments from the sample text content based on a predetermined window size;
constructing training contextual information based on the training associated content; and
training the model based on the sample text segments, sample audio segments corresponding to the sample text segments, and the training contextual information.

10. The method of claim 9, wherein segmenting the sample text content to obtain the sample text segments comprises:
segmenting the sample text content into a plurality of candidate segments based on reference information of the sample text content; and
determining the sample text segments based on the plurality of candidate segments.

11. The method of claim 10, wherein determining the sample text segments based on the plurality of candidate segments comprises:
segmenting, in response to the length of a first candidate segment among the plurality of candidate segments being greater than a threshold, the first candidate segment based on a predetermined length to determine the sample text segment.

12. The method of claim 10, wherein the reference information indicates at least one of:
a grammatical structure of the sample text content, indicating a plurality of sentences of the sample text content; and/or
semantic information of the sample text content, indicating speech expression types corresponding to different content in the sample text content.

13. The method of claim 1, wherein the text content is all content of a chapter of a novel.

14. An electronic device, comprising:
at least one processor; and
at least one memory coupled to the at least one processor and storing instructions executable by the at least one processor, the instructions, when executed by the at least one processor, causing the electronic device to perform acts comprising:
determining, from text content, a text segment to be processed;
constructing contextual information associated with the text segment based on associated content of the text segment in the text content, the associated content comprising at least one of: a preceding segment of the text segment; or a subsequent segment of the text segment; and
providing the text segment and the contextual information to a model to generate audio content corresponding to the text segment, wherein at least one expressive attribute of the audio content is determined based on the contextual information.

15. The electronic device of claim 14, wherein providing the text segment and the contextual information to the model to generate the audio content corresponding to the text segment comprises:
generating an input text embedding based on the text segment and the contextual information;
providing the input text embedding to an autoregressive unit of the model to generate a first audio feature;
providing the first audio feature to a diffusion unit of the model to generate a second audio feature; and
providing the second audio feature to a decoding unit of the model to generate the audio content corresponding to the text segment.

16. The electronic device of claim 15, wherein the input text embedding comprises:
a first part corresponding to the preceding segment;
a second part corresponding to the text segment, wherein the second part is associated with a predetermined identifier; and
a third part corresponding to the subsequent content.

17. The electronic device of claim 15, wherein the first audio feature is a discrete feature, and the second audio feature is a continuous feature.

18. The electronic device of claim 15, wherein providing the input text embedding to the autoregressive unit of the model to generate the first audio feature comprises:
determining a probability distribution of the model with respect to an output token based on the input text embedding;
sorting a plurality of candidate elements based on the probability distribution;
determining a set of candidate elements with a predetermined number from the plurality of sorted candidate elements;
updating sampling probabilities of the set of candidate elements; and
sampling an element corresponding to the output token from the set of candidate elements based on the updated sampling probabilities.

19. The electronic device of claim 18, wherein the acts further comprise:
updating the probability distribution based on a predetermined temperature parameter before sorting the plurality of candidate elements based on the probability distribution.

20. A non-transitory computer-readable storage medium having a computer program stored thereon, wherein the computer program, when executed by a processor, implements acts comprising:
determining, from text content, a text segment to be processed;
constructing contextual information associated with the text segment based on associated content of the text segment in the text content, the associated content comprising at least one of: a preceding segment of the text segment; or a subsequent segment of the text segment; and
providing the text segment and the contextual information to a model to generate audio content corresponding to the text segment, wherein at least one expressive attribute of the audio content is determined based on the contextual information.
